(19) United States
(12) Patent Application Publication
(10) Pub. No.: US 2010/0006654 A1
(43) Pub. Date: Jan. 14, 2010

(54) GAMING CHIP

(75) Inventor: Boris Poel, Heidelberg West (AU)

Correspondence Address: CONNOLLY BOVE LODGE & HUTZ LLP, 1875 EYE STREET, N.W., SUITE 1100, WASHINGTON, DC, 20006, US

(73) Assignee: Elixir Gaming Technologies Inc., Las Vegas, NV (US)

(21) Appl. No.: 12/526,189

(22) PCT Filed: Feb. 12, 2008
(86) PCT No.: PCT/AU2008/000170

§ 371 Date: Aug. 6, 2009

(30) Foreign Application Priority Data
Feb. 13, 2007 (AU) 2007900675

(51) Int. Cl. G06K 19/06

(52) U.S. Cl. 235/492; 235/487

(57) ABSTRACT

An identification token having a label recess in at least one surface thereof, a label adhered to the token within said recess an electronic identification and data device located between said label and the surface of said token recess the improvement comprising the provision of tamper evident lines of weakness in the antenna such that any attempt to remove the antenna and electronic device is easily seen and renders the device unusable.

This invention relates to an improved identification token such as a gaming chip of the kind used in casinos or a medallion used for entry to public venues such as sporting arenas, in particular it is directed to a new construction of token and a method of making it.

### BACKGROUND TO THE INVENTION

Gaming chips with transponders capable of carrying data that can be read and updated from a remote controller are known from U.S. Pat. Nos. 5,651,548 and 5,735,742. A viable system of this type has yet to be implemented. The concept is to have a gaming chip that is identifiable and can be tracked as it moves around the casino. The transponder is adapted to be read and written to so that the identification data can be updated.

Australian patents 699025 and 700269 disclose gaming chip constructions in which an electronic device is embedded in a cell or recess around which the gaming token is moulded. These designs require special moulding operations and expensive tooling in order to accommodate and protect the chip.

U.S. Pat. No. 6,659,875 overcame some of these problems by placing the antenna and RFID chip in the label recess and covering the chip with the gaming chip label. However there are perceptions that the label can be removed and the RFID chip and antenna could be tampered with or replaced.

It is an object of this invention to provide a secure alternative for incorporating an electronic chip into a token or gaming chip.

### BRIEF DESCRIPTION OF THE INVENTION

To this end the present invention provides an identification token having a label recess in at least one surface thereof, a label adhered to the token within said recess an electronic identification and data device located between said label and the surface of said token recess the improvement comprising the provision of tamper evident lines of weakness in the antenna such that any attempt to remove the antenna and electronic device is easily seen and renders the device unusable.

The electronic device is preferably an electronic chip suitable to retain unique identification data and a history of transactions. It may be of the type disclosed in U.S. Pat. No. 5,651,548 which is readable at locations within a casino and capable of sending and receiving data. Usually an antenna will also be needed and this is attached to the electronic chip.

Throughout this specification the term identification token is intended to include a gaming token or chip as used in a casino or a badge medallion or tag used in a similar fashion to a ticket to identify patrons at sporting venues etc. At events like Soccer matches crowd control and security can be assisted if patrons can be identified readily by wireless identification.

Thus in another aspect this invention provides an identification token which includes
a) a body portion having at least one surface
b) a recess in said one surface
c) an antenna printed on a film sized to seat within said recess and said film is adhered to the surface of said recess
d) an electronic identification and data device adhered to said film and connected to said antenna
e) a label adapted to seat within said recess and adhered to said film and said antenna
   wherein said film has been treated to create lines of weakness and the adhesive strength of the bond between the film and the label and/or the film and the surface of said recess is greater than the strength of said film.

### DETAILED DESCRIPTION OF INVENTION

A preferred embodiment of the invention will now be described with reference to the drawings in which:

FIG. 1 is a sectional view of the identification token of this invention;

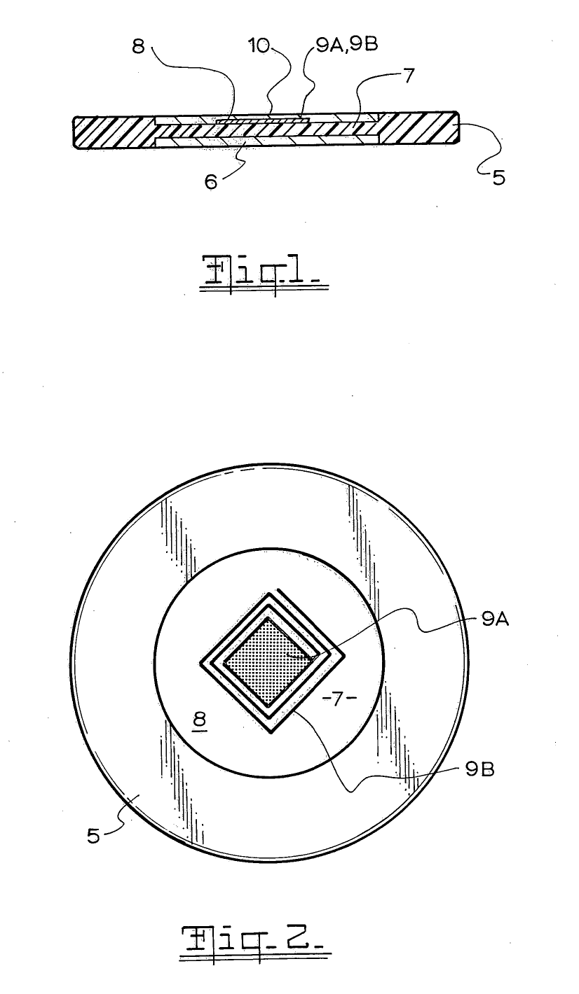

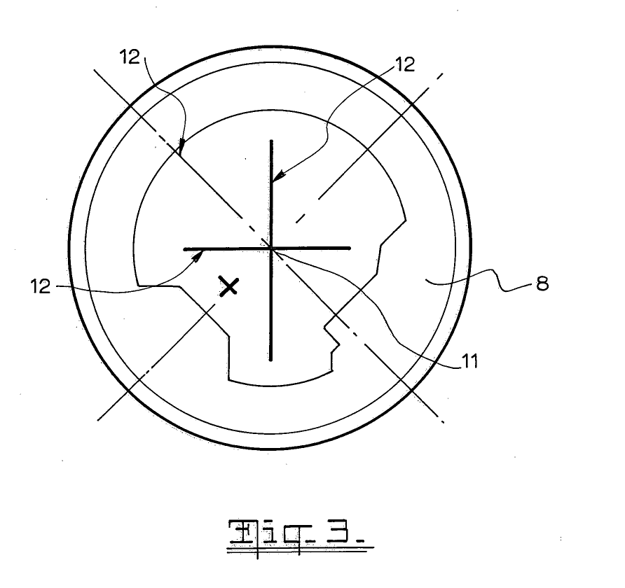

FIG. 2 is plan view of the identification token before the label is applied:

FIG. 3 is a plan view of an inlet for a gaming chip of this invention.

The gaming chip 5 of the kind used in casinos is composed of an injection mouldable synthetic polymer and has a shallow recess 7 in its surface to accommodate labels 6 and 10.

The electronic identification device 9A is a read/write chip operable at 13.56 MHz. It consists of a power supply, a transmitting and receiving system, a data processing unit and a memory block ail adhered to a suitable substrate. This electronic chip has connected to it an aerial 9B. The RFID chip 9A and antenna 9B are mounted on a film inlet 8 sized to seat in the recess 7. The label 10 is adhered to the film 8 to cover the recess 7 and is also adhered to the RFID chip 9A and antenna 9B. The inlet 8 is prepared using reel to reel printing to form the antenna and adhere the RFID chip.

As shown in FIG. 3 the film 3 is perforated at its centre 11 and is slit radially from the centre 11 with slits 12. These slits are located to be at least 0.5 mm from the antenna at any point. This encourages tearing of the film 8 if the label 10 is removed. The selection of adhesives for bonding the film 8 to the recess 7 and for bonding the label 10 to the antenna 9B and film 8 also influences the fracture of the film and the antenna and the provision of a detectable instance of tampering. The adhesive bond between film 8 and label 10 or between film 8 and recess 7 is greater than the strength of the film at the lines of weakness. If the label is partially removed and then replaced although tampering may not be visually evident the rupture of the antenna is evident from the failure of the chip to be read.

The RFID chip 9A in the finished gaming token can be read by readers installed in the casinos. The memory block is a block of non volatile memory which stores information in a permanent form or in an erasable form. The size of the memory and the processor will be determined by the level of information to be stored and processed by the identification device. The receiver circuitry preferably converts received signals into digital impulses which can be deciphered the processor and executes commands received and/or inserts or retrieves information stored in the memory block.

Within a casino environment antenna for addressing the chips [readers] are placed at convenient locations to read and or transmit data to the chips. The readers are conveniently located under the playing surface and are designed to read a stack of up to 25 gaming chips standing 75 mm high as well as the number of stacks that can be accommodated on the playing surface.

When the reader emits a signal to excite the RFID chips, individual chips 9A are programmed to respond individually. Each chip 9A has a unique encrypted serial number or identification and value assigned at the time of manufacture of the gaming chip. When a chip 9A responds to a reader, it is identified and its value, location is stored and tracked by the casino's central processing system. The chip 9A is also capable of receiving information from the reader.

A casino can use the information derived from the location of the chip for some or all of the following:
Security—to detect forgeries by continuously interrogating chips that are in play to ensure that only chips registered for use within the casino are in play.
Player tracking—keeping a record of player transactions and consequently analysing patterns of play.
Auditing—the continuous recording and analysis of the casino's cash flows by table, by type of game is possible which also makes possible the production of immediate profit/loss figures.

From the above it can be seen that the present invention provides a simple and inexpensive improvement to the security of gaming chips. Those skilled in the art will realize that this invention may be implemented in embodiments other than those described, without departing from the core teachings of this invention.

1. An identification token having a label recess in at least one surface thereof, a label adhered to the token within said recess an electronic identification and data device located between said label and the surface of said token recess the improvement comprising the provision of tamper evident lines of weakness in the antenna such that any attempt to remove the antenna and electronic device is easily seen and renders the device unusable.

2. An identification token which includes
a) a body portion having at least one surface
b) a recess in said one surface
c) an antenna printed on a film sized to seat within said recess and said film is adhered to the surface of said recess
d) an electronic identification and data device adhered to said film and connected to said antenna
e) a label adapted to seat within said recess and adhered to said film and said antenna
wherein said film has been treated to create lines of weakness and the adhesive strength of the bond between the film and the label and/or the film and the surface of said recess is greater than the strength of said film.
